(19) United States
(12) Patent Application Publication
(10) Pub. No.: US 2026/0289009 A1
(43) Pub. Date: Sep. 24, 2026

(54) PRIVACY SCRUBBING SOLUTION

(71) Applicant: Wells Fargo Bank, N.A., San Francisco, CA (US)

(72) Inventors: Rajesh A n k s, Hyderabad (IN); Deepta Dhami, Charlotte, NC (US); Patrick C. Eisenman, Monroe, CT (US); Michael David Gathman, Fort Mill, SC (US); Michael Alexander Dunlop MacGill, Charlotte, NC (US); Santosh R. Papagari, Dublin, CA (US); Balaji Vijayakumar, NAMAKKAL (IN)

(21) Appl. No.: 19/692,256

(22) Filed: May 29, 2026

Related U.S. Application Data
(62) Division of application No. 18/932,049, filed on Oct. 30, 2024.

(51) Int. Cl. G06F 21/62

(52) U.S. Cl. CPC G06F 21/6245

(57) ABSTRACT

A system for scrubbing contact information is provided. First data for an individual is received from a first source. The first data has content and a first value. Second data for the individual is received from a second source. The second data has the content and a second value different from the first value. Reconciled data is generated by assigning a tag to the first and second data and comparing the first value with the second value. Reconciled data is also generated by changing the first or second value to the other of the first or second value such that values for the first and second data are consistent. The reconciled data is sent to a consent engine for scrubbing. The reconciled data is scrubbed based on the tag. The scrubbed data is then sent to the first and second sources.

### PRIORITY APPLICATIONS

The present application is a divisional of and claims priority to U.S. application Ser. No. 18/932,049, filed Oct. 30, 2024, the content of which is incorporated herein by reference in its entirety.

### BACKGROUND

An individual may have multiple roles across multiple legal entities. For example, the individual may be an authorized representative at a first legal entity and an assigned preparer at a second legal entity that is different from the first legal entity. Furthermore, the individual may have some other type of authorized role such as an authorized signer at a third legal entity that is different from the first and second legal entities. The individual can be associated with contact information that can include an email address, a physical address, a telephone number, or the like.

The user can assign privacy preferences to the contact information. The privacy preferences can relate to whether or not the individual can be contacted using any of the contact information, such as using an email address to contact the individual or calling the individual using the telephone number. There can also be privacy and solicitation preferences associated with the contact information enforced by government entities. For example, the Telephone Consumer Protection Act (TCPA) and the Canadian Anti-Spam Legislation (CASL) regulate telephone solicitations along with other forms of commercial electronic messages.

However, the contact information and their relationships with different legal entities can be dispersed across various systems, which can lead to data inconsistencies. Furthermore, current infrastructure lacks the capability to consistently maintain the preferences of an individual. Thus, at one legal entity, the individual may have indicated that they can be contacted via their email address while at a second legal entity the individual may have indicated that they should not be contacted via email. Therefore, the individual has the impression that no legal entities will contact them via email.

Furthermore, the contact information should be scrubbed on a continual basis to ensure that the contact information is being used in a manner that does not conflict with the privacy preference of the individual or privacy and solicitation preferences enforced by government entities. Nonetheless, no scrubbing system currently exits which can account for privacy preferences of the user along with privacy and solicitation preferences enforced by government agencies.

### SUMMARY

What is needed is a system and method that solves the problems of disjointed contact information associated with an individual having associations with multiple legal entities. The system should be able to scrub contact information to ensure that the contact information is being used in a manner consistent with privacy preferences of an individual along the privacy and solicitation preferences of any government entities.

Examples relate to a contact master (CM) system that can master preferences for an individual across various entities. The CM system can receive content associated with an individual from multiple sources, such as different customer relation managers (CRMs). Preferences can be associated with the content based on the individual and the source. Accordingly, the content received from a first source can have a first preference associated therewith while the content received from a second source can have a second preference associated therewith. The content received from the first and second sources can be the same content while the first preference can be different from the second preference, thereby creating an inconsistency.

The CM system can enrich the content by first deconstructing the content. The CM system can then reconcile the inconsistency between the first preference and the second preference. The first preference can have a first value and the second preference can have a second value different from the first value where the difference can cause the inconsistency. The CM system can reconcile the inconsistency by comparing the first value with the second value and adjusting either the first value or the second value such that the first value is consistent with the second value. While discussed herein as being reconciled, reconciling content can relate to reconstructing content after deconstructing the content. The CM system can adjust the first value to be the same as the second value. Likewise, the CM system can adjust the second value to the same as the first value.

The CM system can further enrich the content by adding a tag to the deconstructed content along with applying an external factor to the first value and the second value. The tag can relate to a status of the individual, such as whether or not the individual is a client or if the individual is a prospective client. The CM system can receive external factors from a consent engine (CE) and apply the external factor to the content. Based on the external factor, the CM system can change the first value and the second value to the same value.

After the CM system deconstructs the content and enriches the content, the CM system can reconcile the content and provide the reconciled content to the CE. The CE can scrub the reconciled content by applying the reconciled content to a rules engine to determine a solicitation preference associated with the reconstructed content. The solicitation preference can be based on the tag. The CM system can receive the scrubbed content having the solicitation preference and reconstruct the content to generate a scrubbed version of the of content. After reconstruction, the CM system can forward along the scrubbed reconciled content to the sources.

### BRIEF DESCRIPTION OF FIGURES

FIG. 1 shows an environment in which examples may operate, in accordance with examples.

FIG. 2 is a method that illustrates a CM system of FIG. 1 managing preferences for an individual across different CRMs also shown in FIG. 1, in accordance with examples.

FIGS. 3-8 show various scenarios where contact information received from CRMs is mastered by a CM system of FIG. 1 in conjunction with a consent engine of FIG. 1, in accordance with examples.

FIG. 9 is a block diagram showing one example of a software architecture for a computing device, in accordance with examples.

FIG. 10 is a block diagram illustrating a computing device hardware architecture, within which a set or sequence of instructions can be executed to cause the machine to perform examples of any one of the methodologies discussed herein, in accordance with examples.

### DETAILED DESCRIPTION

Examples relate to a contact master (CM) system that can master preferences for an individual across various entities. The CM system can receive data associated with an individual from multiple sources, such as different customer relation managers (CRMs). Preferences can be associated with the data based on the individual and the source. Accordingly, the data received from a first source can have a first preference associated therewith while the data received from a second source can have a second preference associated therewith. The data received from the first and second sources can be the same content while the first preference can be different from the second preference, thereby creating an inconsistency.

The CM system can enrich the data by first deconstructing the data. The CM system can then reconcile the inconsistency between the first preference and the second preference. The first preference can have a first value and the second preference can have a second value different from the first value where the difference can cause the inconsistency. The CM system can reconcile the inconsistency by comparing the first value with the second value and adjusting either the first value or the second value such that the first value is consistent with the second value. In particular, the CM system can adjust the first value to be the same as the second value. Likewise, the CM system can adjust the second value to the same as the first value.

The CM system can further enrich the data by adding a tag to the deconstructed data along with applying an external factor to the first value and the second value. The tag can relate to a status of the individual, such as whether or not the individual is a client or if the individual is a prospective client. The CM system can receive external factors from a consent engine (CE) and apply the external factor to the data. Based on the external factor, the CM system can change the first value and the second value to the same value.

After the CM system deconstructs the data and enriches the data, the CM system can provide the deconstructed data to the CE. The CE can scrub the deconstructed data by applying the reconstructed data to a rules engine to determine a solicitation preference associated with the reconstructed data. The solicitation preference can be based on the tag. The CM system can receive the scrubbed deconstructed data having the solicitation preference and reconstruct the data to generate a scrubbed version of the of data. After reconstruction, the CM system can forward along the scrubbed reconstructed data to the sources.

Examples improve the functioning of computing devices by improving database management capabilities of a CM system, which can be a computing device. A CM system manages a database that includes a golden copy (GC) of data. The GC can be continually updated where the continual updates improve the ability of the CM system to provide accurate data. When data associated with an entry at the GC is received from a single source, the CM system can automatically determine if the received data differs from the entry in the GC. If there are any differences, the CM system can adjust the data in the GC.

In addition, the CM system determines if adjustments should be made to the entry in the GC based on the received data, whether the received data requires further changes, and if updates should be sent to other sources associated with the entry. This enhances the functionality of the CM system by improving the speed with which the CM system can provide updated entries at the GC to sources associated with the updated entries.

Prior computing systems ran the risk of having entries in a database that were not up to date. As such, prior computing systems ran the risk of not allowing sources associated with the entries to have the most up to data entries. By providing the systems and methods disclosed herein, this potential computing problem can be addressed.

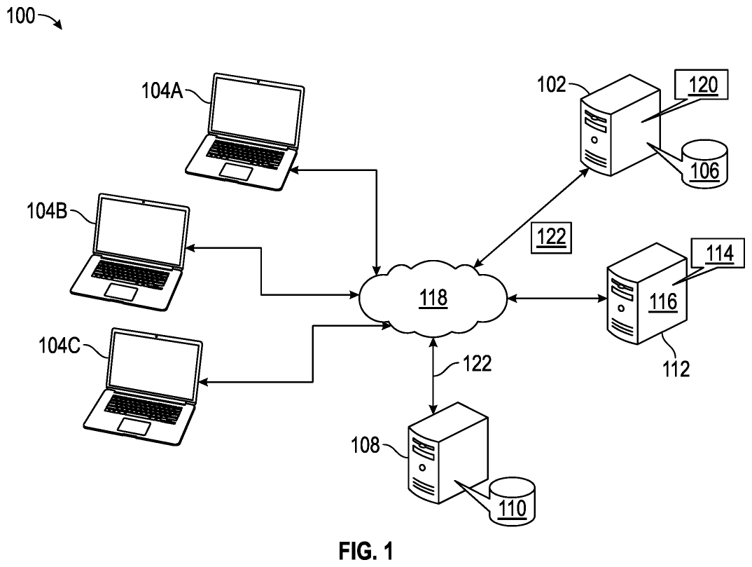

Now making reference to FIG. 1, an environment 100 is shown in which examples can operate. The environment 100 can include a CM system 102 and relational manager (RM) devices 104A-C along with a database 106. The CM system 102 and the RM devices 104A-C can incorporate an architecture that facilitates operation in the capacity of either a server of a client machine in server-client network environments, where each of these devices may be implemented as any type of computing device, such as a server computer, a personal computer (PC), or the like each having a processor configured to perform the subject matter disclosed herein. The RM devices 104A-C can be any computing device suitable for use by a user. For example, the devices may be a desktop computer, a tablet computer, a portable media device, or a smart phone belonging to a user. In addition, the CM system 102 can include a local database 106, which can allow local storage of data associated with various individuals such that the CM system 102 can function as a master data management repository.

The environment 100 can also include a software-as-a-service (SaaS) management platform 108 that can be associated with a database 110. The SaaS management platform 108 can be a system separate from the CM system 102 and generate information associated with individuals with whom CRMs associated with the RM devices 104A-C can interact. The information can be stored at the database 110. The information can include a type of individual with whom CRMs interact. For example, the individual can be a client or a potential client. The information can also indicate whether or not the individual with whom CRMs interact can be contacted via a survey to discuss the experience of the individual with a CRM or a legal entity represented by the CRM. Whether or not the individual should be contacted can relate to a preference of the individual.

The environment 100 can also include a consent engine 112 that is associated with a database 114. The database 114 can include rules gleaned from a third party that can be associated with how individuals can be contacted when the individuals and CRMs have a client relationship. To further illustrate, the rules can relate to how an individual who is a potential client can be contacted and how an individual who is a client can be contacted.

The database 114 can also include external factors that can affect how an individual can be contacted. These external factors can be environmental, such as if the individual is at a location that is being or has been recently subjected to abnormal weather phenomena, such as a hurricane, a blizzard, or the like. The external factors can also relate to if the individual is at a location that has been subjected to a natural disaster, such as an earthquake, flooding, or the like. The external factors can be dispositive of whether or not the individual should be contacted for client purposes. The CE 112 can forward these external factors to the CM system 102, which can store the external factors at the database 106. In addition, the external factors can be used as rules by the CE 112 to determine how an individual should be contacted.

The CE 112 can have a rules engine 116 that can execute the rules in a runtime production environment. The rules engine 116 can allow legal entities associated with the CM system 102 to define, manage, and automate decision-making processes. In examples, each of the legal entities can have a relationship with another legal entity. For example, the legal entities associated with the CM system 102 could all be associated with the same legal entity where the associated legal entities can be sub-entities of the same legal entity. In other examples, the legal entities associated with the CM system 102 could be part of a consortium. Regardless, the preferences can extend across all of the legal entities including the parent legal entity in instances where the legal entities associated with the CM system 102 are sub-entities of a legal entity or across the consortium. The rules engine 116 can apply the rules stored in the database to data sent from the CM system 102.

The databases 106, 110, and 114 can be any type of data storage resource and can store data structured as a text file, a table, a spreadsheet, a triple store, a hierarchical data store, or any suitable combination thereof. Moreover, the CM system 102 and the database 106 can be combined into a single machine, database, or device, and the functions described herein for any single machine, database, or device may be subdivided among multiple machines, databases, or devices.

The CM system 102, the RM devices 104A-C, the SaaS management platform 108, and the CE 112 can communicate via a network 118. The network 118 can be any network that enables communication between or among machines, databases, and devices (e.g., the CM system 102, the RM devices 104A-C, the SaaS management platform 108, and the CE 112). Accordingly, the network 118 can be a wired network, a wireless network (e.g., a mobile or cellular network), or any suitable combination thereof. The network 118 can include one or more portions that constitute a private network, a public network (e.g., the Internet), or any suitable combination thereof. Accordingly, the network 118 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 118 can communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

The CM system 102 can include a golden copy (GC) 120 that can store a data set that can be baseline data associated with an individual. The GC 120 and the data set can be stored locally at the database 106. The baseline data can be agnostic information associated with the individual. In particular, the baseline data can be the same regardless of an association of the individual with different legal entities, different roles the individual can have, different products the individual can be handling or responsible for, and the like. The baseline data associated with an individual can include a name of the individual, an internal database identifier associated with the individual, and contact information for the individual. However, the baseline data is not restricted to these examples.

The GC 120 can be created and continually updated with a mastering process where data associated with an individual is gathered from various sources. The contact information at the GC 120 can be a telephone number of an individual, a telephone number and an extension of an individual, an email address of an individual, a physical address of an individual, and any other type of information that can relate to how an individual can be contacted. The GC 120 can be continually mastered when the contact information for an individual changes or further contact information is received for the individual. These changes can relate to how an individual can be contacted as a result of the change. These changes can include if a type of the individual changes or a location associated with the individual is affected by an external factor, as will be detailed further below.

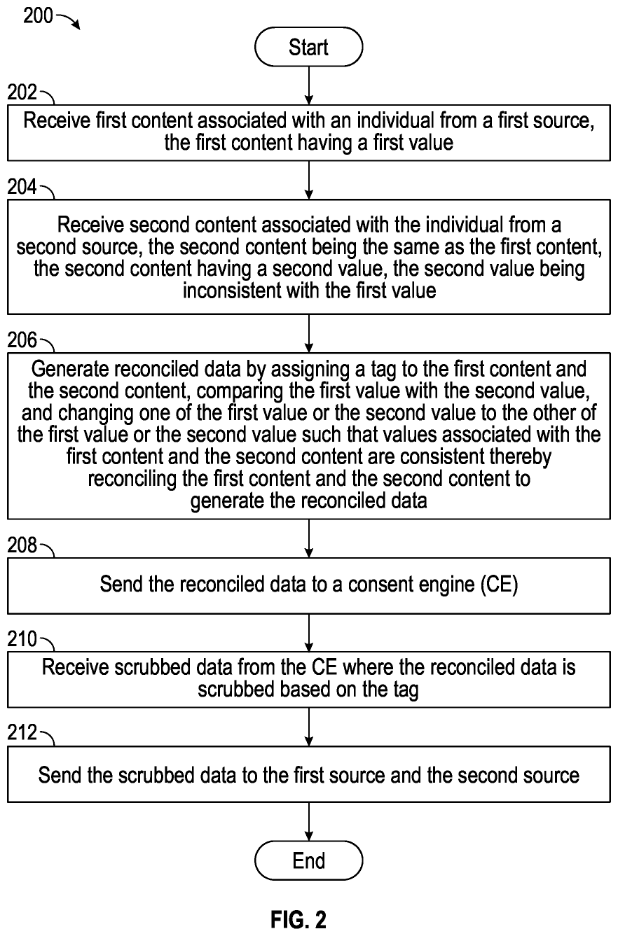

As noted above, examples relate to a contact master (CM) system that can manage preferences for an individual across various entities. Now making reference to FIG. 2, a method 200 that illustrates a CM system managing preferences for an individual across different CRMs is shown. The method 200 can deconstruct content received from sources and reconcile the deconstructed content to generate reconciled data. Reconciling the content can enrich the content by applying external factors to received content and updating preferences in the form of values as will discussed further below.

Initially, the method 200 can perform an operation 202, where first content associated with a first individual can be received from a first source. The first content can include a first value. The first source can be a CRM. The first content can be contact information as detailed above while the first value can relate to a status of the contact information. To further illustrate, the first value can be an indication relating to whether or not the individual can be contacted via the contact information. Thus, if the first content is a telephone number and the individual indicates to the first source that the individual can be contacted via the telephone number, the first value can correspond to “OKAY TO CALL.” If the first content is an email address and the individual indicates to the first source that the individual can be contacted via the email address, the first value can correspond to “OKAY TO EMAIL.” If the first content is a physical address and the individual indicates to the first source that the individual can be contacted via the physical address, the first value can correspond to “OKAY TO MAIL.”

The method 200 can also perform an operation 204, where second content associated with the first individual can be received from a second source. The second content can include a second value. The second content can be the same as the first content and have the same properties as the first content. Thus, the second content can match the first content. The second value can be an indication relating to whether or not the individual can be contacted via the contact information as mentioned above. In examples, the second value can be the same as the first value.

In further examples, the second value can be inconsistent with the first value. Thus, if the second content is a telephone number and the individual indicates to the second source that the individual cannot be contacted via the telephone number, the second value can correspond to “NOT OKAY TO CALL,” which would be inconsistent with the first value that corresponds to “OKAY TO CALL.” If the second content is an email address and the individual indicates to the second source that the individual cannot be contacted via the email address, the second value can correspond to “NOT OKAY TO EMAIL,” which would be inconsistent with the first value that corresponds to “OKAY TO EMAIL.” If the second content is a physical address and the individual indicates to the second source that the individual cannot be contacted via the physical address, the second value can correspond to “NOT OKAY TO MAIL,” which would be inconsistent with the first value, which corresponds to “OKAY TO MAIL.”

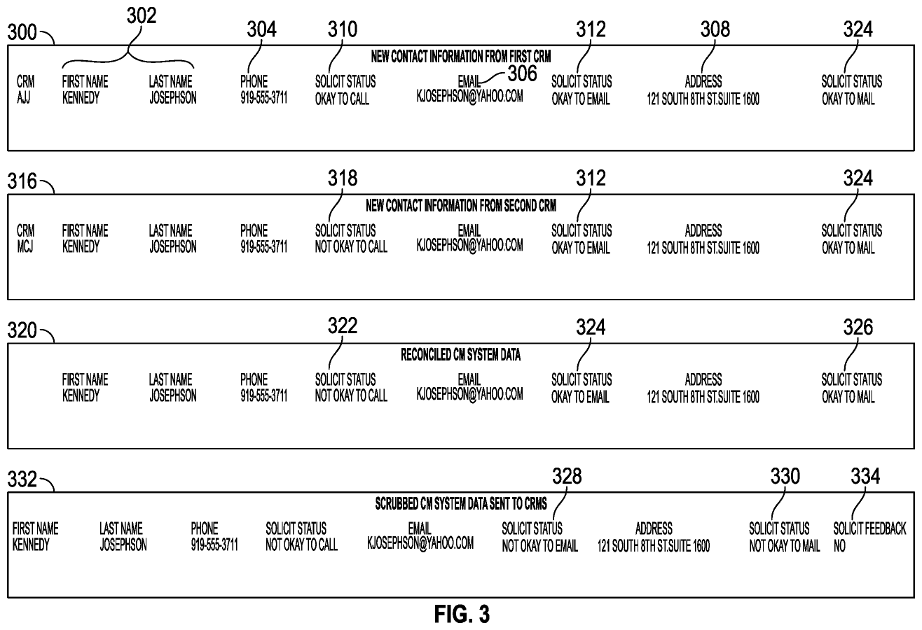

As an illustration of the method 200 and referred to herein as “the illustration,” reference is made to FIGS. 1 and 3. During the operation 202, a CRM AJJ associated with the RM device 104A can send first content 300 associated with an individual 302 to the CM system 102 during the operation 202. The first content 300 can include contact information having a telephone number 304, an email address 306, and a physical address 308. In addition, the first content 300 can include a first value 310, which can correspond to “OKAY TO CALL.” Thus, the first content 300 can indicate that the individual is okay with being contacted via the telephone number 304. The first content 300 can also have a value 312 associated with the email address 306, which can correspond to “OKAY TO EMAIL,” and a value 314 associated with the physical address 308, which can correspond to “OKAY TO MAIL.”

During the operation 204, a CRM MCJ associated with the RM device 104B can send second content 316 associated with the individual 302 to the CM system 102. The second content 316 can include the same contact information as the first content information 300 as shown in FIG. 3. However, the second content 316 can include a second value 318 that indicates that the individual 302 is not okay with contacting them via the telephone number 304. Therefore, the second value 318 is inconsistent with the first value 310.

Returning to FIG. 2, after the operation 204, the method 200 can perform an operation 206, where reconciled data can be generated. The content received during the operations 202 and 204 can be deconstructed where the first values and the second values can be deconstructed to the values that correspond to a preference associated with an individual, such as “OKAY TO CALL,” “NOT OKAY TO CALL,” “OKAY TO EMAIL,” “NOT OKAY TO EMAIL,” “OKAY TO MAIL,” “NOT OKAY TO MAIL,” or the like.

The reconciled data can be generated by assigning a tag to the first content and the second content. Additionally, the reconciled data can be generated by comparing the first value with the second value and changing one of the first value or the second value to the other of the first value or the second value. As such, the first value or the second value can be changed to another of the first value or the second value. The first value or the second value can be changed such that such that the first value and the second value can be consistent with each other. The data can be reconciled when the first value and the second value are consistent with each other.

The tag, which can be stored at the SaaS management platform 108, can refer to a type of an individual, such as if the individual is current client or a prospective client. When the type refers to whether or not an individual is a current client or a prospective client, the type can dictate if the individual can be contacted. For example, if the individual 302 is a current client, the individual can be contacted via the telephone number 304, the email address 306, the physical address 308, or any other type of medium, unless otherwise specified by the individual 302, such as the individual 302 indicating to a CRM that the individual 302 does not wish to be contacted.

Alternatively, if the individual 302 is a prospective client, the individual cannot be contacted via the telephone number 304, the email address 306, the physical address 308, or any other type of medium. This can be regardless even if the individual 302 specified to a CRM that the individual 302 can be contacted. Therefore, if an individual has indicated to all CRMs that the individual can be contacted via any or all the contact information and this is reflected in the content as a value that can include one of “OKAY TO CALL,” “OKAY TO EMAIL,” and/or “OKAY TO MAIL,” the first value can be reconciled to a second value, which can correspond to not contacting the individual via the contact information, such as “NOT OKAY TO CALL,” “NOT OKAY TO EMAIL,” and/or “NOT OKAY TO MAIL.”

The tag can also refer to a status of the individual. The status can be whether or not the individual is willing to be contacted to discuss their experience with the CRM or the legal entity with which the CRM is associated. If an individual is willing to be contacted to discuss their experience, when the reconciled data is generated, this can be included in the reconciled data. If an individual is not willing to be contacted to discuss their experience, when the reconciled data is generated, this can be included in the reconciled data.

During the operation 206, the first value can be compared with the second value. If there as inconsistency between the first value and the second value, the CM system 102 can reconcile the first and second values to by changing the first value to the second value. In further examples, the second value can be changed to the first value. Moreover, any combination of all the values, such as the values 312 and 314 can also be changed as discussed with reference to the first value 310 and the second value 318.

The first value or the second value can be changed to be consistent with the other of the first value or the second value based on timestamps associated with each of the first content and the second content. More specifically, the value associated with the content having the later timestamp can be used. Thus, if the second content has a later timestamp than the first content, the second value can be used where the first value is changed to the second value.

Alternatively, a quantity of values can be used to determine a value. To further illustrate, if five CRMs return content having the first value while three CRMs return content having the second value, the second value can be changed to the first value. Historical data can also be used to determine which value to select. To further illustrate, if the individual typically does not like to be contacted during a certain time of year, such as between December 25^{th} and January 2^{nd}, this historical data can be used to determine which of the first value or the second value should be changed to be made consistent with the other of the first value or the second value.

Values can also be determined based on a trustworthiness of the CRM. If a first CRM historically is more trustworthy then a second CRM, then the preference from the first CRM can be used. Machine learning models can be used to determine the trustworthiness of a CRM. In the historical example, machine learning models can be provided with training data relating to preferences associated with a user. Here, the training data can relate to identifying the first CRM as relating to providing preferences that are typically not adjusted by a user associated with the preference. Machine learning models can be implemented to identify other preferences from the CRM as being more trustworthy than other CRMs. Furthermore, machine learning models can be trained over time with data relating to new CRMs and the trustworthiness associated with the new CRMs where the trustworthiness can change over time. In particular, the preference from the first CRM associated with the user may start to be changed based on the user changing preferences of the user. More specifically, he user now tends to keep a preference provided from a second CRM. Therefore, the second CRM has become more trustworthy over time. This information can be provided to the machine learning model as training data at a second time and used to train the machine learning model such that the machine learning model changes over time.

In addition, the CM system can receive external factors from the CE either prior to reconciling the data or while the CM system reconciles the data. The CM system can use the external factors to further reconcile the first and second values. Thus, if any of each of the values indicate “OKAY TO CALL,” “OKAY TO EMAIL,” and “OKAY TO MAIL,” if a location of the individual was subject to an external factor as listed above, the CM system can change the values to “NOT OKAY TO CALL,” “NOT OKAY TO EMAIL,” “NOT OKAY TO MAIL” during the operation 206.

Returning to the illustration and FIGS. 1 and 3, during the operation 206, the CM system 102 accesses the SaaS management system platform 108 to determine if there are any tags associated with the individual 302. The SaaS management platform 108 includes a tag 122 that indicates the individual is a prospective client and that the individual is not receptive to providing feedback relating to their experience with the CRM. This can be referred to tag information in the illustration. Moreover, during the operation 206, the first value 310 can be compared with the second value 318. Here, a determination is made that the first value 310 is inconsistent with the second value 318. In the illustration, the first value 310 indicates “OKAY TO CALL” and the second value 318 indicates “NOT OKAY TO CALL.” Accordingly, during the operation 206, the CM system 102 reconciles the first content 300 with the second content 316 to generate reconciled data 320 by creating a third value 322, which indicates that it is “NOT OKAY TO CALL” the individual 302. In particular, the first content 300 can have a timestamp T₁ while the second content 316 can have a timestamp T₂, which is later than the timestamp T₁. Based on the later time stamp T₂, the third value 322 is consistent with the second value 318. As such, the first content 300 can be made consistent with the second content 316 since each of the first content 300 and the second content 316 can be made to have the value “NOT OKAY TO CALL” as shown int eh reconciled data 320.

Returning to FIG. 2, after reconciling the data during the operation 206, the method 200 can perform an operation 208, where the CM system sends the reconciled data to a CE. The CM system can also send tag information to the CE when the reconciled data is sent. The tag information can relate to information in the tag sent by the SaaS management platform. The CE can scrub the reconciled data by making any changes to the values based on the tag information. The CE can also scrub the reconciled data based on any external factors that were either not sent to the CM system or not considered by the CM system.

When the CE scrubs the reconciled data, this can relate to the CE changing any values based on the tag information and any external factors not considered by the CM system. Thus, if a tag indicates that the individual is a prospective client, the CE can scrub the reconciled data to indicate that the individual should not contacted. This can be done by applying the rules engine to the reconciled data, the tag, and any external factors. For example, the CE can change, or confirm, that the values are “NOT OKAY TO CALL,” “NOT OKAY TO EMAIL,” and “NOT OKAY TO MAIL.” This can be based on solicitation preferences enforced by a government agency. Therefore, the tag can be used by the CE to enforce solicitation preferences.

Returning to the illustration and FIGS. 1 and 3, during the operation 208, the CM system 102 can send the reconciled data to the CE 112. When the CM system 102 sends the reconciled data 320 to the CE 112, the CM system 102 also sends the tag information to the CE 112 indicating that the individual 302 is a prospective client. After the CE 112 receives the reconciled data 320, the CE 112 scrubs the reconciled data 320 by searching for any external factors relevant to a location of the individual 302 along with checking the tag information indicating that the individual 302 is a prospective client. Moreover, the CE 112 scrubs the reconciled data 320 by using the rules engine 116 to apply the tag information to the reconciled data 320. In the illustration, when an individual is a prospective client, the individual may not be contacted. As such when the CE 112 scrubs the reconciled data 320 during the operation 208 by applying the rules engine 116 to the reconciled data 320, the rules engine 116 changes the value 324 to a value 328, which indicates that it is “NOT OKAY TO EMAIL” the individual 302. The rules engine 116 also changes the value 326 to a value 330, which indicates that it is “NOT OKAY TO MAIL” the individual 302.

Returning to FIG. 2 and the method 200, the CM system receives scrubbed data from the CE during an operation 210. Furthermore, the CM system updates the reconciled data to generate scrubbed data and then sends the scrubbed data to the first source and the second source during an operation 212. During the operation 212, the CM system can update the data to reflect any changes received from the CE, such as any changes to any values based on the tag information and/or any external factors that may not have been applied by the CM system. This can be part of the mastering process where the scrubbed data is sent to the GC. The CM can also generate the scrubbed data to indicate whether or not feedback should be solicited from the individual based on the tag received from the SaaS management platform.

Turning attention back to the illustration and FIG. 3, after the CE 112 changes the values 324 and 326, the CM system 102 receives the scrubbed data from the CE 112 during the operation 210. During the operation 212, the CE system 112 generates scrubbed data 332, which reflects that the values 324 and 326 have been updated to the values 328 and 330. Moreover, the tag information received from the SaaS management platform 108 indicated that the individual 302 is not willing to provide feedback. Therefore, the CM system 102 includes a value 334 in the scrubbed data 332 that shows the individual 302 is not willing to provide feedback. Accordingly, a survey relating to the experience the individual 302 had with the CRMs associated with the RM devices 104A and 104B will not be sent to the individual 302. Once the scrubbed data 332 is generated by the CM system 102, the CM system 102 sends the scrubbed data 332 to the CRMs associated with the RM devices 104A and 104B.

Machine learning models can be used with the CE to determine how external factors should be applied to the content received from various sources. In the external factors example above, machine learning models can be provided with training data relating to previous events occurring at locations that could impact the ability of an individual to respond to communications sent to the individual before, during, and after the event. For example, during a weather event, such as a blizzard, which can be sent to the CE as an external factor, typical reactions to individuals at the location associated with the weather event can be provided to the CE to determine if values associated with a communication should be one of “NOT OKAY TO CALL,” “NOT OKAY TO EMAIL,” or “NOT OKAY TO MAIL.” Here, the training data could indicate that during a weather event, these values should be such that the individual will not be contacted at all. However, at a later time, a determination can be made that while the individual should not be called, individuals are receptive to receiving emails or physical mail since they can attend to this after the weather event subsides. Therefore, second training data can be provided to the machine learning model and the CE indicating that when a weather event, such as a blizzard, is an external factor, instead of assigning the values “NOT OKAY TO CALL,” “NOT OKAY TO EMAIL,” or “NOT OKAY TO MAIL,” if the values are “OKAY TO CALL,” “OKAY TO EMAIL,” and “OKAY TO MAIL,” only the value “OKAY TO CALL” should be changed to “NOT OKAY TO CALL” while the other values can remain the same. Furthermore, machine learning models at the CE can be trained over time with data relating to new external factors and how individuals change their response to being contacted over time such that machine learning models at the CE can change over time.

In addition to external factors that can affect how a machine learning model at the CE can change over time, as noted above, a type of an individual can affect a value where the value assigned by a CRM can change over time. The type can be provided as training data to the machine learning model at the CE such that the CE can determine if a value should be changed. However, at a later time, rules may change regarding the type such that these changes can be provided as training data to the machine learning model at the CE. Based on the rule changes, the machine learning model at the CE can change such that the machine learning model at the CE can again change over time.

One or more machine learning algorithms are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with input and, optionally, users. The statistical model is trained based on multiple attributes (or factors) described herein. In machine learning parlance, such attributes are referred to as “features.” To generate and train a statistical model, a set of features is specified and a set of training data is identified.

Examples are not limited to any particular machine learning technique for generating or training a machine learning model. Example machine learning techniques include linear regression, logistic regression, neural networks, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

Machine learning can also envision the use of fuzzy matching where fuzzy matching can use various inbuild matching algorithms (a blend of probabilistic, heuristic, linguistic, phonetic, and/or empirical methods) based on the type of data being matched, with built-in algorithms for phonetic spellings and partial fields. This combination of approaches provides great flexibility and generates accurate results.

Initially, the number of features that are considered for training may be significant. After training a machine learning model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future models and computing output scores.

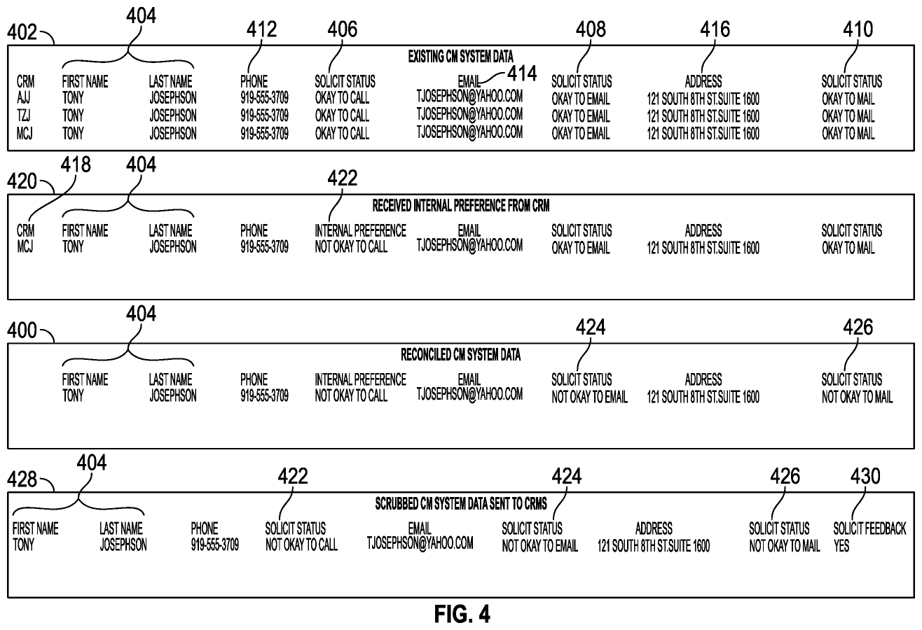

In addition to the illustration described above with reference to FIGS. 1 and 3, there can be a number of other scenarios in which examples of the mastering process can operate. For example, in FIG. 4, a scenario can occur where reconciled data 400 can be generated based on an external factor that can relate to a natural disaster. Content 402 stored at the CM system 102 can list various contact information for an individual 404. The content 402 can include values 406-410, which can respectively correspond to “OKAY TO CALL,” “OKAY TO EMAIL,” and “OKAY TO MAIL,” a telephone number 412, an email address 414, or a physical address 416.

A CRM 418 may provide content 420, which can have a value 422 corresponding to “NOT OKAY TO CALL.” The CM system 102 can also receive an indication of an external factor that can be a natural disaster occurring at a location corresponding to the physical address 416. Therefore, when the CM system 102 generates the reconciled data 400, the CM system 102 can update the value 408 to value 424, which can correspond to “NOT OKAY TO EMAIL,” and the value 410 to value 426, which can correspond to “NOT OKAY TO MAIL.” The reconciled data 400 can be sent to the CE 112 as described, where the CE 112 can scrub the reconciled data 400, also as described above. When the CE 112 scrubs the reconciled data 400, the CE 112 can indicate that feedback can be solicited from the individual 404. Therefore, when the CM system 102 generates scrubbed data 428, the scrubbed data 428 can include a value 430, which can show that the feedback can be solicited from the individual 404. The GC 120 can be mastered to include the scrubbed data 428 by sending the scrubbed data 428 to the GC 120.

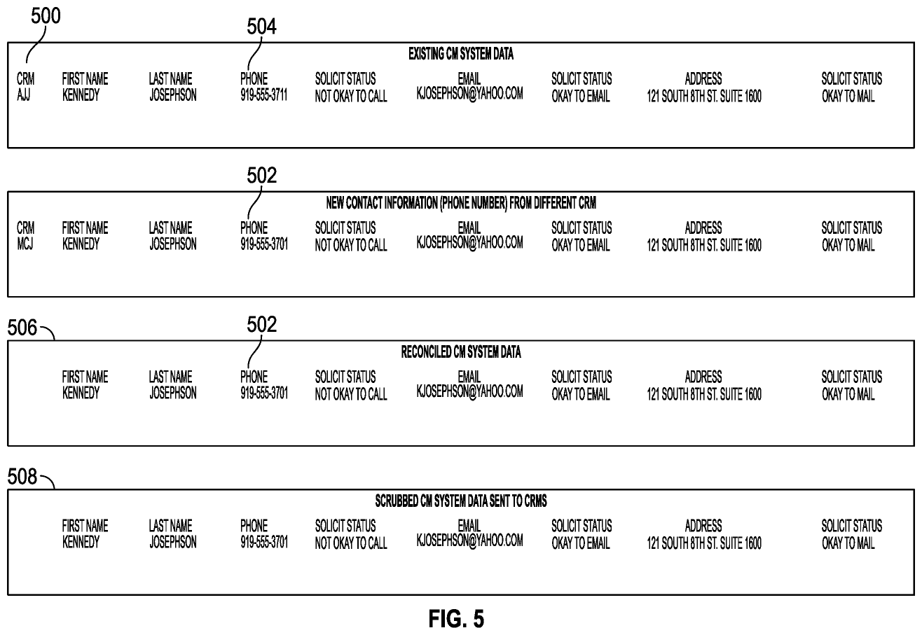

FIG. 5 illustrates an example where a CRM 500 provides a telephone number 502 that differs from a telephone number 504 stored at the CM system 102. In this example, the CM system 102 generates reconciled data 506 to replace the telephone number 504 with the telephone number 502 as described above. The CM system 102 can then send the reconciled data 506 to the CE 112. The CE 112 can scrub the reconciled data 506 as discussed above and send the scrubbed data back to the CM system 102. The CM system 102 can then send along scrubbed data 508 to the CRMs, which can be generated using the scrubbed data received from the CE 112 as described above. Here, the GC 120 can be mastered to include the scrubbed data 508 by sending along the scrubbed data 508 to the GC 120.

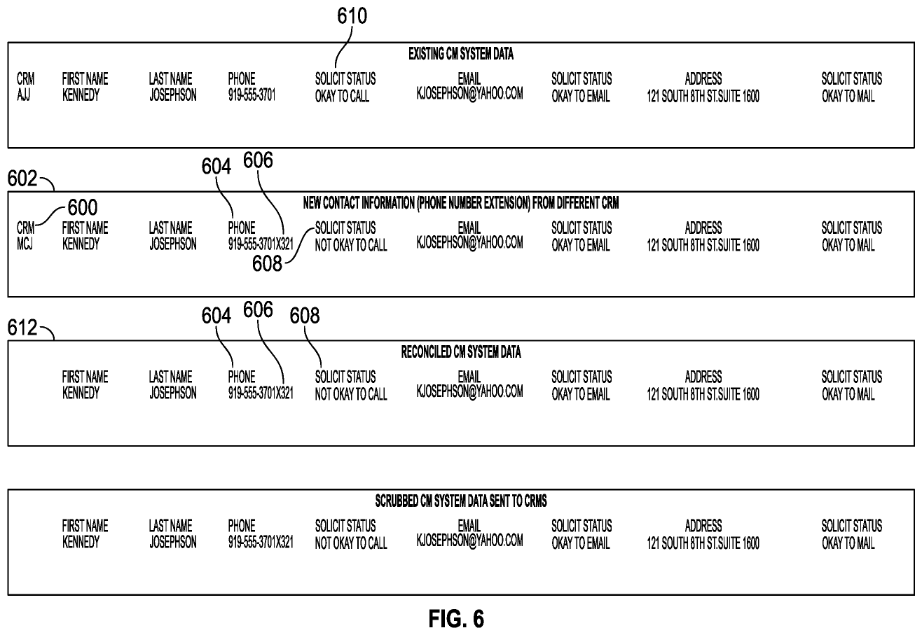

FIG. 6 is a scenario showing where a CRM 600 provides content 602 having a telephone number 604 and an extension 606 that is not stored at the CM system 102. The content 602 also includes a value 608 corresponding to “NOT OKAY TO CALL.” The value 608 differs from a value 610 that corresponds to “OKAY TO CALL.” The CM system 102 can create reconciled data 612 that has the extension 606 along with the value 608. The CM system 102 can then send the reconciled data 612 to the CE 112. The CE 112 can scrub the reconciled data 612 as discussed above and send the scrubbed data back to the CM system 102. The CM system 102 can then send along scrubbed data 614 to the CRMs.

While the example of FIG. 6 illustrates the scenario where one CRM did not list the extension 606, in some scenarios a phone number with the extension can be listed as a work phone number while the phone number without the extension can be listed as a mobile phone number. Here, the GC 120 can be mastered to have the phone number with the extension listed as a work phone number for the individual while the phone number without the extension can be listed as a mobile phone number for the individual.

Moreover, the example of FIG. 6 describes a scenario where there is a single extension. In further examples, the same phone number can have different extensions for different phone types. Thus, a phone number may have a first extension for a work phone number. The same phone number may have a second extension for a mobile phone number. The GC 120 can be mastered using the techniques described herein to associate the same phone number with different extensions to different phone number types, such as the mobile phone number and the work phone number.

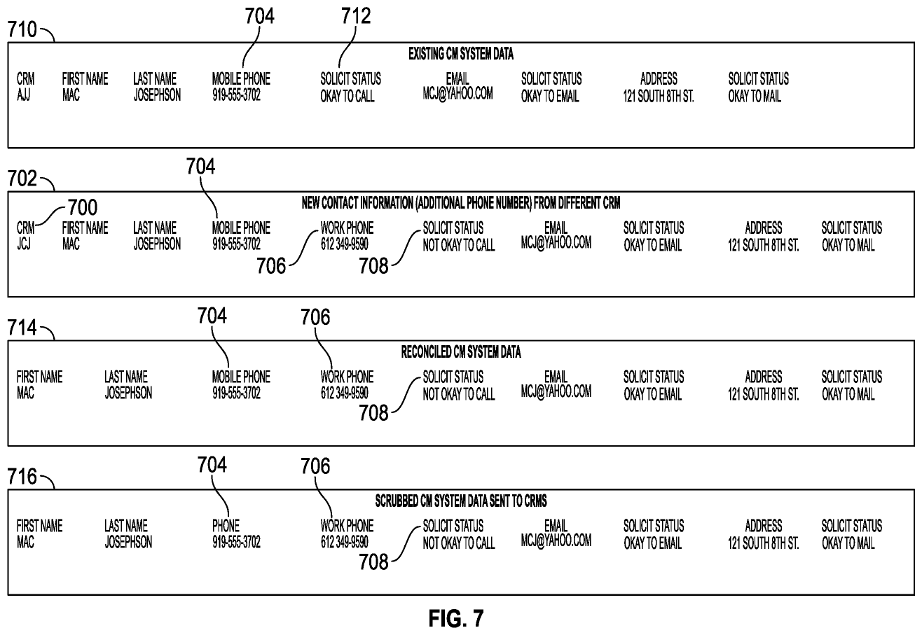

FIG. 7 shows an example where a CRM 700 provides content 702 that includes a mobile phone number 704 along with a work phone number 706. The content 702 also has a value 708 that corresponds to “NOT OKAY TO CALL.” Content 710, which is the GC version of the individual associated with the content 702 and is stored at the CM system 102 along with the GC 120, does not include the work phone number 706. Moreover, the content 710 includes a value 712 corresponding to “OKAY TO CALL.” The CM system 102 can create reconciled data 714 that includes the mobile phone number 704 along with the work phone number 706. The reconciled data 714 also has the value 708 that corresponds to “NOT OKAY TO CALL.” The CM system 102 can then send the reconciled data 714 to the CE 112. The CE 112 can scrub the reconciled data 714 as discussed above and send the scrubbed data back to the CM system 102. The CM system 102 can generate scrubbed data 716 and then send along the scrubbed data 716 to the CRMs.

While the example of FIG. 7 illustrates the scenario where multiple phones numbers are associated with an individual, in some scenarios, a single phone number can have different labels. To further illustrate one CRM can have the single phone number listed as a work phone number for an individual and another CRM can have the single phone number listed as a mobile phone number for the same individual. In examples, the GC 120 can be mastered to have the single phone number listed as both the work phone number and the mobile phone number for the same individual.

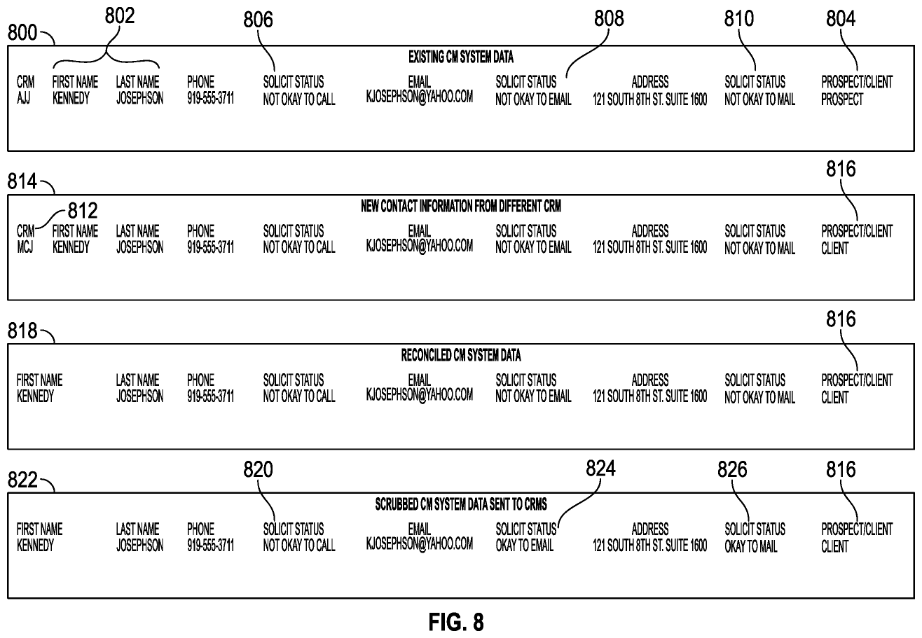

As detailed above, the SaaS management platform 108 can store data relating to whether an individual is a prospective client of a legal entity associated with a CRM or a client of a legal entity associated with a CRM. In some instances, an individual can switch from a prospective client to a client. Making reference to FIG. 8, content 800 can reflect that an individual 802 is a prospect 804. Therefore, the content 800 can have the values 806-810. The value 806 can correspond to “NOT OKAY TO CALL,” the value 808 can correspond to “NOT OKAY TO EMAIL,” and the value 810 can correspond to “NOT OKAY TO MAIL.”

However, in the illustration of FIG. 8, at a later time, a CRM 812 can provide content 814 that can reflect that the individual 802 is now a client 816. This information relating to the individual 802 being a current client can be sent to the SaaS management platform 108. Additionally, the CM system 102 can create reconciled data 818 that can reflect that the individual 802 is now a client 816. When the CE 112 receives the reconciled data 818 and subsequently scrubs the data as discussed above, the CE 112 can send scrubbed data back to the CM system 102 where a value 820, as shown in content 822, can correspond to “OKAY TO CALL.” The content 822 can also include a value 824, which can correspond to “OKAY TO EMAIL.” Moreover, the content 822 can have a value 826, which can correspond to “OKAY TO MAIL.” The CE 112 can scrub the data that can be used to create the values 820, 824, and 826 based on the change from the prospect 804 to the client 816. The CM system 102 can then send the content 102 to CRMs.

The CE 112 can scrub reconciled data or data stored in the GC 120 on a regular and continual basis, such as once a day, every four hours, once a week etc. Moreover, when the CE 112 receives an update for an individual, such as the removal of an external factor, the CE 112 can send a request to the CM system 102 to scrub data associated with the individual on an ad hoc basis. The inverse can also occur. Thus, when the CE 112 becomes aware of an external factor associated with the individual the CE 112 can send a request to the CM system 102 to scrub data associated with the individual on an adhoc basis.

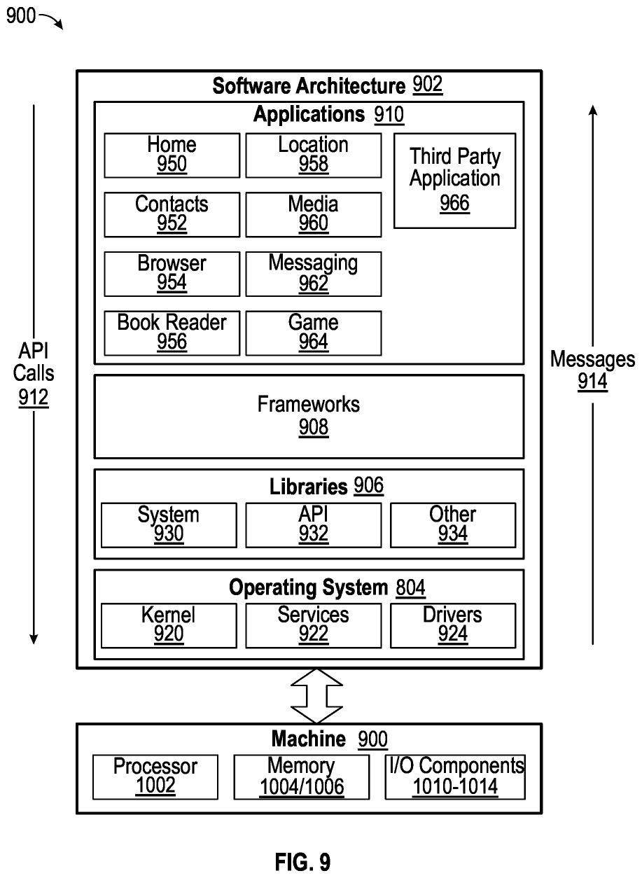

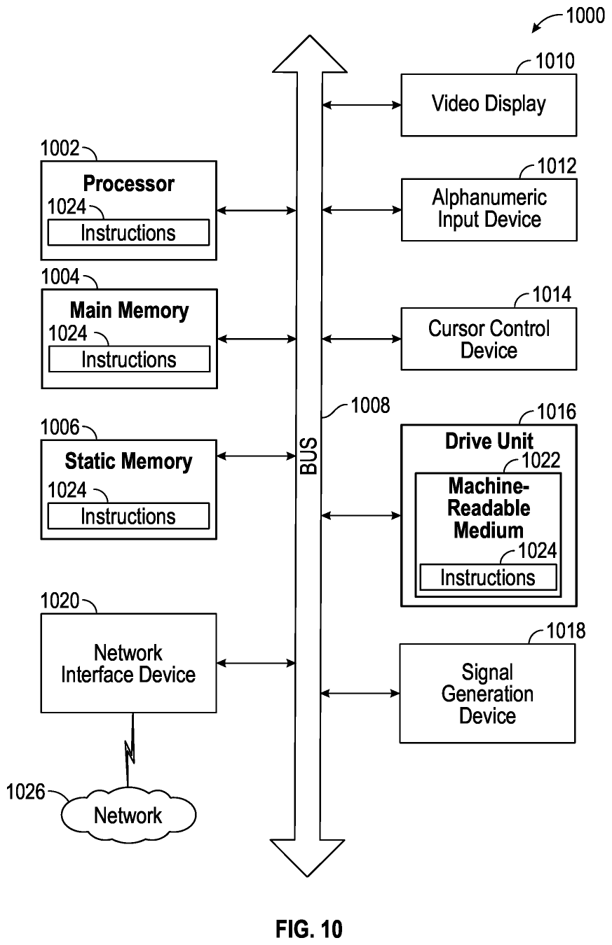

FIG. 9 is a block diagram 900 illustrating a software architecture 902, which may be installed on any one or more of the devices described above. FIG. 9 is merely a non-limiting example of a software architecture, and it will be appreciated that many other architectures may be implemented to facilitate the functionality described herein. The software architecture 802 may be implemented by hardware such as a machine 1000 of FIG. 10 that includes a processor 1002, memory 1004 and 1006, and I/O components 1010 -1014. In this example, the software architecture 902 may be conceptualized as a stack of layers where each layer may provide a particular functionality. For example, the software architecture 902 includes layers such as an operating system 904, libraries 906, frameworks 908, and applications 910. Operationally, the applications 910 invoke application programming interface (API) calls 912 through the software stack and receive messages 914 in response to the API calls 912, according to some implementations.

In various implementations, the operating system 904 manages hardware resources and provides common services. The operating system 904 includes, for example, a kernel 920, services 922, and drivers 924. The kernel 920 acts as an abstraction layer between the hardware and the other software layers in some implementations. For example, the kernel 920 provides memory management, processor management (e.g., scheduling), component management, networking, and security settings, among other functionality. The services 922 may provide other common services for the other software layers. The drivers 924 may be responsible for controlling or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 906 provide a low-level common infrastructure that may be utilized by the applications 910. The libraries 906 may include system libraries 930 (e.g., C standard library) that may provide functions such as memory allocation functions, string manipulation functions, mathematic functions, and the like. In addition, the libraries 906 may include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 may also include a wide variety of other libraries 934 to provide many other APIs to the applications 910.

The frameworks 908 provide a high-level common infrastructure that may be utilized by the applications 910, according to some implementations. For example, the frameworks 908 provide various graphic user interface (GUI) functions, high-level resource management, high-level location services, and so forth. The frameworks 908 may provide a broad spectrum of other APIs that may be utilized by the applications 910, some of which may be specific to a particular operating system or platform.

In an example, the applications 910 include a home application 950, a contacts application 952, a browser application 954, a book reader application 956, a location application 958, a media application 960, a messaging application 962, a game application 964, and a broad assortment of other applications such as a third-party application 966. According to some examples, the applications 910 are programs that execute functions defined in the programs. Various programming languages may be employed to create one or more of the applications 910, structured in a variety of manners, such as object-orientated programming languages (e.g., Objective-C, Java, or C++) or procedural programming languages (e.g., C or assembly language). In a specific example, the third-party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 966 may invoke the API calls 912 provided by the mobile operating system (e.g., the operating system 904) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 118 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 10 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device (cursor control device) 1014 (e.g., a mouse), a disk drive unit 1016, a signal generation device 1018 (e.g., a speaker) and a network interface device 1020.

The drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. Instructions 1024 may also reside within the static memory 1006.

While the machine-readable medium 1022 is shown in an example to be a single medium, the term “machine-readable medium” may include a single medium or multiple media (e.g., a centralized or distributed database, and/or associated caches and servers) that store the one or more instructions or data instructions 1024. The term “machine-readable medium” shall also be taken to include any tangible medium that is capable of storing, encoding or carrying instructions 1024 for execution by the machine and that cause the machine to perform any one or more of the methodologies of the present invention, or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1024 for execution by the machine, and includes digital or analog communications signals or other intangible media to facilitate communication of such software.

In various example examples, one or more portions of the network 1026 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1026 or a portion of the network 1026 may include a wireless or cellular network, and the coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

1. A system comprising:
processing circuitry; and
a memory device including instructions embodied thereon, wherein the instructions, which when executed by the processing circuitry, configure the processing circuitry to perform operations that:
receive first data associated with an individual from a first source, the first data having first content and a first value for the first content;
receive second data associated with the individual from a second source, the second data having:
second content that matches the first content; and
a second value for the second content, the second value being inconsistent with the first value;
generate reconciled data by:
assigning a tag to the first data and the second data, wherein the tag relates to a type of the individual;
comparing the first value with the second value; and
changing one of the first value or the second value to another of the first value or the second value such that values associated with the first data and the second data are consistent;
send the reconciled data to a consent engine (CE);
receive scrubbed data from the CE, the reconciled data being scrubbed based on the tag; and
send the scrubbed data to the first source and the second source.

2. The system of claim 1, wherein the first content is contact information for the individual and the tag is indicative of contacting the individual using the contact information based on the type of the individual.

3. The system of claim 1, wherein the type of the individual indicates whether the individual is a first individual type or a second individual type.

4. The system of claim 3, wherein:
when the individual is the first individual type, the reconciled data is generated by changing the first value and the second value to indicate that the individual is not to be contacted; and
when the individual is the second individual type, the reconciled data is generated such that the first value and the second value indicate that the individual can be contacted.

5. The system of claim 3, wherein the scrubbed data received from the consent engine reflects a change in the first value and the second value based on the change from the first individual type to the second individual type.

6. The system of claim 1, wherein the tag is received from a software-as-a-service management platform separate from the system.

7. The system of claim 1, wherein the instructions further configure the processing circuitry to:
update a copy stored at a database local to the system based on the type of the individual indicated by the tag; and
receive updated data indicating a change in the type of the individual from a first source, and generate updated reconciled data based on the change in the type.

8. The system of claim 1, wherein the consent engine applies a rules engine to the reconciled data based on the type of the individual to generate the scrubbed data.

9. A non-transitory, machine-readable medium, comprising instructions, which when performed by a processor of a machine, causes the processor to perform operations to:
receive first data associated with an individual from a first source, the first data having first content and a first value for the first content;
receive second data associated with the individual from a second source, the second data having:
second content that matches the first content; and
a second value for the second content, the second value being inconsistent with the first value;
generate reconciled data by:
assigning a tag to the first data and the second data, wherein the tag relates to a type of the individual;
comparing the first value with the second value; and
changing one of the first value or the second value to another of the first value or the second value such that values associated with the first data and the second data are consistent;
send the reconciled data to a consent engine (CE);
receive scrubbed data from the CE, the reconciled data being scrubbed based on the tag; and
send the scrubbed data to the first source and the second source.

10. The non-transitory, machine-readable medium of claim 9, wherein the first content is contact information for the individual and the tag is indicative of contacting the individual using the contact information based on the type of the individual.

11. The non-transitory, machine-readable medium of claim 9, wherein the type of the individual indicates whether the individual is a first individual type or a second individual type.

12. The non-transitory, machine-readable medium of claim 11, wherein:
when the individual is the first individual type, the reconciled data is generated by changing the first value and the second value to indicate that the individual is not to be contacted; and
when the individual is the second individual type, the reconciled data is generated such that the first value and the second value indicate that the individual can be contacted.

13. The non-transitory, machine-readable medium of claim 11, wherein the scrubbed data received from the consent engine reflects a change in the first value and the second value based on the change from the first individual type to the second individual type.

14. The non-transitory, machine-readable medium of claim 9, wherein the instructions causes the processor to perform operations to:
update a copy stored at a database local to a system based on the type of the individual indicated by the tag; and
receive updated data indicating a change in the type of the individual from a first source, and generate updated reconciled data based on the change in the type.

15. The non-transitory, machine-readable medium of claim 9, wherein the consent engine applies a rules engine to the reconciled data based on the type of the individual to generate the scrubbed data.

16. A method comprising:
receiving first data associated with an individual from a first source, the first data having first content and a first value for the first content;
receiving second data associated with the individual from a second source, the second data having:
second content that matches the first content; and
a second value for the second content, the second value being inconsistent with the first value;
generating reconciled data by:
assigning a tag to the first data and the second data, wherein the tag relates to a type of the individual;
comparing the first value with the second value; and
changing one of the first value or the second value to another of the first value or the second value such that values associated with the first data and the second data are consistent;
sending the reconciled data to a consent engine (CE);
receiving scrubbed data from the CE, the reconciled data being scrubbed based on the tag; and
sending the scrubbed data to the first source and the second source.

17. The method of claim 16, wherein the first content is contact information for the individual and the tag is indicative of contacting the individual using the contact information based on the type of the individual.

18. The method of claim 16, wherein the type of the individual indicates whether the individual is a first individual type or a second individual type.

19. The method of claim 18, wherein:
when the individual is the first individual type, the reconciled data is generated by changing the first value and the second value to indicate that the individual is not to be contacted; and
when the individual is the second individual type, the reconciled data is generated such that the first value and the second value indicate that the individual can be contacted.

20. The method of claim 18, wherein the scrubbed data received from the consent engine reflects a change in the first value and the second value based on the change from the first individual type to the second individual type.
